(19) United States
(12) Patent Application Publication
(10) Pub. No.: US 2022/0260264 A1
(43) Pub. Date: Aug. 18, 2022

(54) Humidification Apparatus

(71) Applicant: AUTOELEX CO., LTD., Gimhae-si (KR)

(72) Inventor: Jong-yoon BAE, Gimhae-si (KR)

(21) Appl. No.: 17/570,597

(22) Filed: Jan. 7, 2022

(30) Foreign Application Priority Data
Feb. 17, 2021 (KR) 10-2021-0021210

(51) Int. Cl. F24F 6/10; F24F 11/00

(52) U.S. Cl. CPC F24F 6/10; F24F 2006/008; F24F 11/0008

(57) ABSTRACT

Disclosed herein is a humidification apparatus. The humidification apparatus includes: a frame installed inside a water storage part in which water is stored, and having a heating means mounting hole and fan mounting depression in which parts for providing moisture are mounted; a heating means inserted into and mounted in the heating means mounting hole of the frame, and configured to heat the water stored in the water storage part; and a fan assembly mounted vertically in the fan mounting depression of the frame, and configured to transfer or discharge water vapor, generated from the water heated by the heating means, to a space requiring humidification. The heating means includes a heating member configured such that the lower portion thereof is immersed in the water and heats the water, a heater member configured to generate heat to be transferred to the heating member, and a heating means frame.

### CROSS-REFERENCE TO RELATED APPLICATION

This application claims the benefit of Korean Patent Application No. 10-2021-0021210 filed on Feb. 17, 2021, which is hereby incorporated by reference herein in its entirety.

### BACKGROUND

### 1. Technical Field

The present invention relates generally to a humidification apparatus, and more particularly to a humidification apparatus that provides a structure capable of overcoming multiple problems caused by water in a heating means, thereby stably performing humidification inside an apparatus.

### 2. Description of the Related Art

In general, a humidification apparatus is an apparatus that controls humidity in a space by generating water vapor from water.

Such a humidification apparatus is provided in a space where the air is dry or high humidity is required and controls humidity in a room or an apparatus.

For example, in the case of an incubator in which eggs are artificially hatched, the hatching rate can be improved only when the eggs accommodated therein maintain the same conditions as those in nature.

In this case, the incubator needs to maintain appropriate temperature and humidity. To control these conditions, the incubator is provided with a built-in humidification apparatus.

As described above, such humidification apparatuses are provided not only in apparatuses requiring humidification, such as incubators but also in humidification apparatuses used indoors to prevent dry atmospheres or diseases, and maintain appropriate humidity.

The prior art regarding such a humidification apparatus is disclosed in Korean Utility Model Registration No. 20-0460879, etc.

According to the prior art, a humidification apparatus is installed inside an apparatus requiring humidification, and performs humidification by transferring water vapor, generated from water heated by a heater, to the inside through a fan.

Meanwhile, in this prior art, the fan is always exposed above water. Accordingly, even when the humidification apparatus is not in use, the water under the fan evaporates and water droplets condense on the fan, thereby causing the disadvantages of reducing the durability of the fan and also increasing the failure rate due to corrosion.

In addition, in the prior art humidification apparatus, a heater configured to heat water and a temperature sensor are simply surrounded by a shrink tube, so that there are problems in that durability is insufficient to protect the heater from the outside and foreign substances easily adhere thereto.

Moreover, the shrink tube surrounding the heater and the temperature sensor is located inside a heater cover. Accordingly, when a considerable quantity of contaminants such as foreign substances are caught in the heater cover, the heater cover and the shrink tube need to be separated and removed. As a result, there are disadvantages in that a removal process is inconvenient and also in that when contaminants are caught as described above, the efficiency of the heater decreases, and thus it is difficult to heat water to a temperature desired by a user.

### SUMMARY

An object of the present invention is to provide a humidification apparatus that may improve durability and quality by providing a structure capable of overcoming multiple problems caused by water in a heating means, thereby stably performing humidification in an apparatus.

Another object of the present invention is to provide a humidification apparatus that has the function of detecting and provides notification of the fact that there is no water in the water storage part of the humidification apparatus, thereby efficiently performing humidification inside an apparatus.

The objects of the present invention are not limited to the objects described above, and other objects not described will be clearly understood by those of ordinary skill in the art from the following description.

In order to accomplish the above objects, the present invention provides a humidification apparatus including: a frame installed inside a water storage part in which water is stored, and having a heating means mounting hole and fan mounting depression in which parts for providing moisture are mounted; a heating means inserted into and mounted in the heating means mounting hole of the frame, and configured to heat the water stored in the water storage part; and a fan assembly mounted vertically in the fan mounting depression of the frame, and configured to transfer or discharge water vapor, generated from the water heated by the heating means, to a space requiring humidification; wherein the heating means includes: a heating member configured such that the lower portion thereof is immersed in the water stored in the water storage part and heats the water; a heater member provided in a compressed state in the upper portion of the heating member to be spaced apart from the water, and configured to generate heat to be transferred to the heating member; and a heating means frame configured to cover the top of the heating member provided with the heater member, to expose both outer surfaces of the lower portion of the heating member, and to fill the inside of the heating member.

The heating member may have an inverted U-shaped side section and also have at least one rib, connecting both sides thereof, therein; and the heater member may be provided in a compressed state on the uppermost rib of the heating member.

The heater member may be one of a positive temperature coefficient (PTC) heater, a resistance heater, and a ceramic heater.

The heating means may include connecting lines that are connected to the heater member and protrude from one side of the upper portion of the heating means frame.

The heating means may include a sealing member that is provided on the uppermost rib of the heating member to block both exposed sides of the heater member in order to waterproof the heater member provided in a compressed state on the uppermost rib of the heating member.

The humidification apparatus may further include a temperature and humidity sensor that is provided to be spaced apart from the fan assembly to a space requiring humidification, detects a temperature and humidity between the fan assembly and the space requiring humidification, and sends a signal providing notification that there is no water in the water storage part when a set humidity is not reached even after a set temperature was reached and then a predetermined period has elapsed.

The humidification apparatus may include a safety cover having at least one hole that exposes a portion while enclosing both outer surfaces of the exposed lower portion of the heating member.

An air inlet hole configured such that water vapor generated from water heated by the heating means is introduced or transferred to the fan assembly therethrough may be formed in a portion of the frame on one side of the fan mounting depression.

At least one air circulation hole configured to circulate air may be formed in a portion of the frame adjacent to the heating means mounting hole in which the heating means is mounted.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view illustrating a humidification apparatus according to an embodiment of the present invention;

FIG. 2 is an exploded perspective view illustrating a humidification apparatus according to an embodiment of the present invention;

FIGS. 3A and 3B are a front view and a side sectional view illustrating a heating means, which is a component of a humidification apparatus according to an embodiment of the present invention;

FIGS. 4A and 4B are an assembled perspective view and an exploded perspective view illustrating a method of coupling the heater member and heating member of a heating means, which is a component of a humidification apparatus according to an embodiment of the present invention;

FIG. 5 is a perspective view illustrating a state in which a humidification apparatus according to an embodiment of the present invention is mounted in the water storage part of a humidification housing; and

FIG. 6 is a side sectional perspective view showing the flow of air in order to illustrate a process in which a humidification apparatus humidifies the humidification target area of a humidification housing according to an embodiment of the present invention.

### DETAILED DESCRIPTION

Embodiments of the present invention will be described in detail with reference to the accompanying drawings. Advantages and features of the present invention, and a method of achieving them, will become apparent with reference to the embodiments described below in detail in conjunction with the accompanying drawings. However, the present invention is not limited to the embodiments described herein, and may be embodied in different forms. Rather, the embodiments introduced herein are provided such that this disclosure may be made thorough and complete and the spirit of the present invention may be sufficiently conveyed to those of ordinary skill in the art. The present invention is only defined by the scope of the claims.

Throughout the specification, the same reference characters designate the same components. Accordingly, the same or similar reference characters may be described with reference to other drawings even when not mentioned or described in the corresponding drawings. In addition, although reference characters are not indicated in corresponding drawings, descriptions may be made with reference to other drawings.

The terms used herein are intended to describe embodiments, but are not intended to limit the present invention. In this specification, a singular expression also includes a plural expression unless specifically stated otherwise in the context. As used herein, the terms “includes” and/or “including” specify the presence of stated features, integers, steps, operations, elements, and/or components, but do not preclude the presence or addition of one or more other features, integers, steps, operations, elements, components, and/or groups thereof. In addition, since reference characters are given in the order of description according to an embodiment, the reference characters are not necessarily limited to the order.

When a component is described as being “connected” or “coupled” to another component, it is understood that they may be directly connected or coupled to each other or they may be connected or coupled to each other with a third component disposed therebetween. In contrast, a component is described as being “directly connected” or “directly coupled” to another component, it is understood that they are connected or coupled to each other without a third element therebetween. The term “and/or” may include all combinations of a plurality of described items

The spatially relative terms “below,” “beneath,” “lower,” “above,” “upper,” etc. may be used to easily describe the spatial relationship between a device or component and one or more other devices or components. The spatially relative terms should be understood as terms including different orientations of the device in use or operation in addition to the orientation shown in a drawing. For example, when the device shown in the drawing is turned over, a device described as being placed “below” or “beneath” the former device may be placed “above” the former device. Accordingly, the exemplary term “below” may include both orientations regarding “below” and “above.” The device may also be placed in other orientations, and thus spatially relative terms may be interpreted according to orientation.

Furthermore, the embodiments described herein will be described with reference to sectional and/or plan views, which are ideal illustrative views of the present invention. In the drawings, the thicknesses of films and regions may be exaggerated for the effective description of technical items. Accordingly, the shapes of the illustrative drawing may be modified due to manufacturing technology and/or tolerance. Accordingly, the embodiments of the present invention are not limited to the specific shapes illustrated in the drawings, but also include changes in shape generated according to a manufacturing process. As a result, the regions illustrated in the drawings have schematic features, and the shapes of the illustrated regions in the drawings are intended to illustrate specific shapes of the regions of an apparatus, but are not intended to limit the scope of the invention.

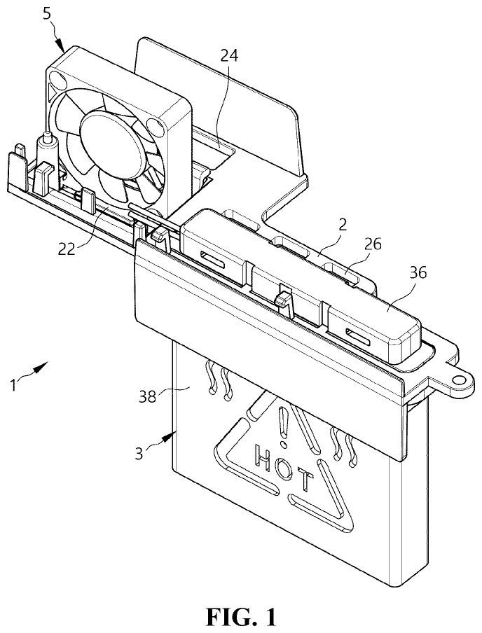

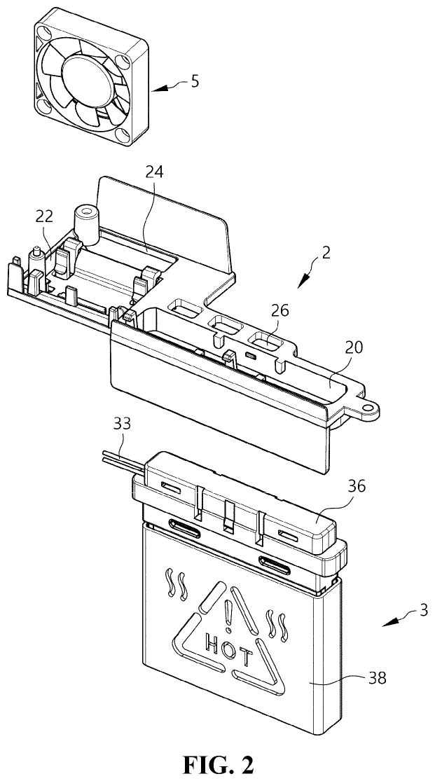

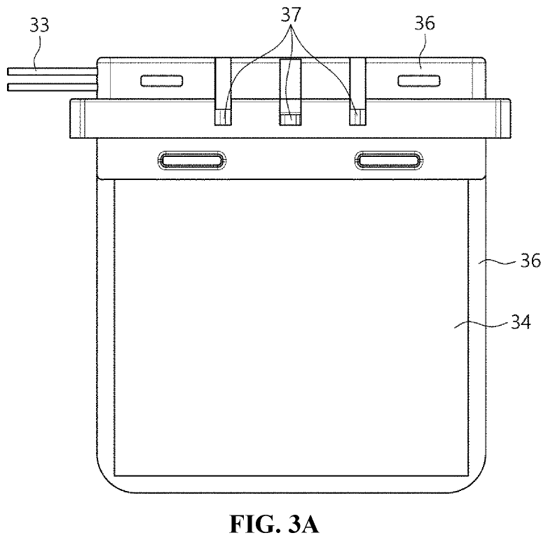

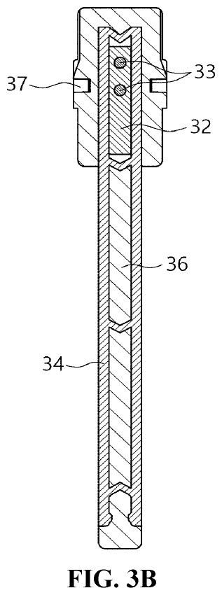

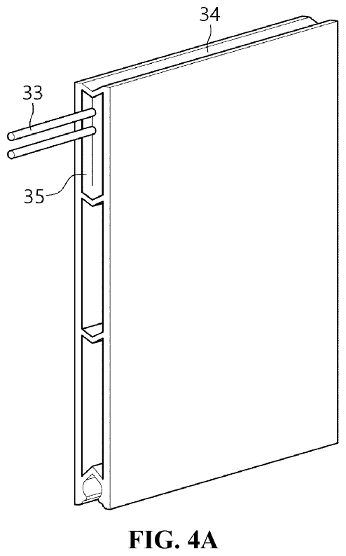

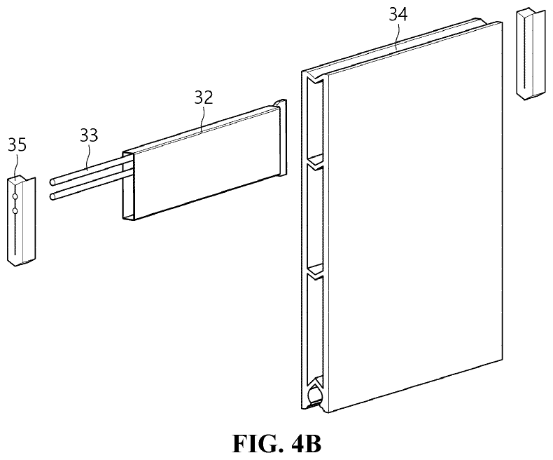

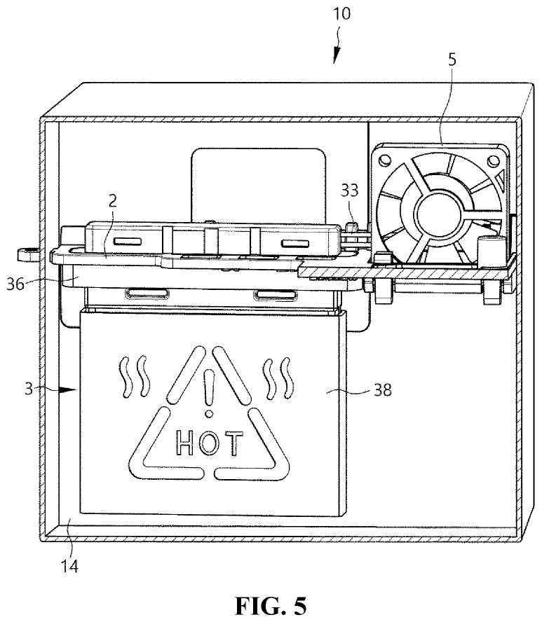

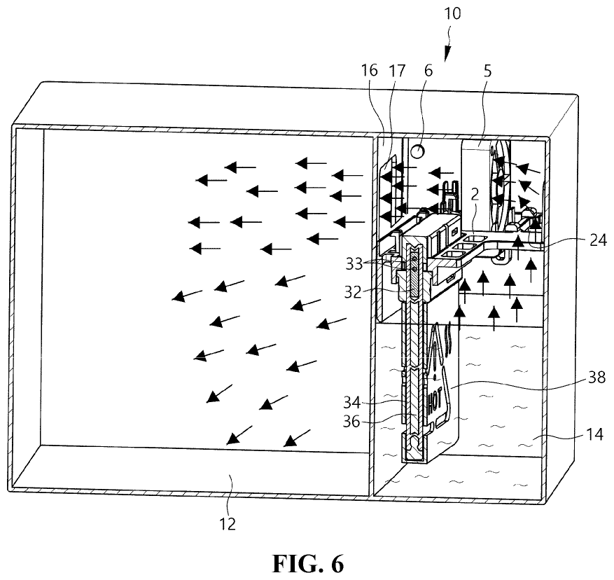

FIG. 1 is a perspective view illustrating a humidification apparatus according to an embodiment of the present invention; FIG. 2 is an exploded perspective view illustrating a humidification apparatus according to an embodiment of the present invention; FIGS. 3A and 3B are a front view and a side sectional view illustrating a heating means, which is a component of a humidification apparatus according to an embodiment of the present invention; FIGS. 4A and 4B are an assembled perspective view and an exploded perspective view illustrating a method of coupling the heater member and heating member of a heating means, which is a component of a humidification apparatus according to an embodiment of the present invention; FIG. 5 is a perspective view illustrating a state in which a humidification apparatus according to an embodiment of the present invention is mounted in the water storage part of a humidification housing; and FIG. 6 is a side sectional perspective view showing the flow of air in order to illustrate a process in which a humidification apparatus humidifies the humidification target area of a humidification housing according to an embodiment of the present invention.

Referring to FIGS. 1 to 6, the humidification apparatus 1 is contained and installed in an apparatus. The humidification apparatus 1 basically includes a frame 2 configured such that parts configured to perform humidification are mounted thereon, a heating means 3 configured to heat water, and a fan assembly 5 configured to transfer water vapor generated from the heated water. The heating means 3 and the fan assembly 5 are connected to a controller (not shown) that performs operations according to a user's settings, so that they can be operated by receiving power and signals.

The humidification apparatus 1 according to an embodiment of the present invention, which is configured as described above, may easily supply moisture in a space requiring humidification. Furthermore, the humidification apparatus 1 is made of materials with desirable durability and thermal conductivity, so that it can prevent failures attributable to the corrosion of parts and the deterioration of heater efficiency.

The humidification apparatus 1 includes: a frame 2 installed inside a water storage part 14 in which water is stored, and configured such that a heating means mounting hole 20 and a fan mounting depression 22 are formed therein such that parts for providing moisture are mounted therein; a heating means 3 inserted into and mounted in the heating means mounting hole 20 of the frame 2, and configured to heat the water stored in the water storage part 14; and a fan assembly 5 mounted vertically in the fan mounting depression 22 of the frame 2, and configured to transfer or discharge water vapor, generated from the water heated by the heating means 3, to a humidification target area 12, which is a space requiring humidification.

In this case, the heating means 3 may include: a heating member 34 configured such that the lower portion thereof is immersed in water stored in the water storage part 14 and heats the water; a heater member 32 provided in a compressed state in the upper portion of the heating member 34 to be spaced apart from the water, and configured to generate heat to be transferred to the heating member 34; and a heating means frame 36 configured to cover the top of the heating element 34 provided with the heater element 32, to expose both outer surfaces of the lower portion of the heating element 34, and to fill the inside of the heating element 34.

These configurations will be described in more detail for individual components as follows:

First, the frame 2 is a part on which a plurality of parts for performing humidification is mounted.

This frame 2 is formed in a plate-like shape, and is also formed to have a stubby L shape when viewed from above, as shown in FIG. 1.

The heating means mounting hole 20 in which the heating means 3 to be described later will be mounted is formed across the lateral part of the stubby L-shaped frame 2 in the longitudinal direction of the lateral portion.

Furthermore, the fan mounting depression 22 in which the fan assembly 5 to be described later will be mounted is formed across the vertical part of the stubby L-shaped frame 2.

Next, the heating means 3 is a means for heating water.

The heating means 3 basically includes the heater member 32, the heating member 34, and the heating means frame 36, as shown in FIG. 2.

The heater member 32 may include one of a positive temperature coefficient (PTC) heater, a resistance heater, and a ceramic heater. However, the present invention is not limited thereto. The heater member 32 of the humidification apparatus 1 according to an embodiment of the present invention may include various heaters capable of transferring heat to the heating member 34.

In this case, the heating means frame 36 is a portion that is inserted into and mounted in the heating means mounting hole 20 of the frame 2.

It is preferable that the heating means frame 36 have the same shape as the heating means mounting hole 20 in order to be inserted into and fixed in the heating means mounting hole 20.

Furthermore, as shown in FIG. 2, the heating means frame 36 has a plurality of heating means frame coupling recesses 37, to be engaged with the heating means mounting hole 20, in the front and rear surfaces thereof.

In this case, protrusions to be engaged with the heating means frame coupling recesses 37 of the heating means frame 36 are formed on the inner surface of the heating means mounting hole 20. A number of protrusions equal to the number of the heating means frame coupling recesses 37 are preferably formed in the same shape and at the same locations as the heating means frame coupling recesses 37 formed in the heating means frame 36.

Since the protrusions and the recesses are formed as described above, the heating means frame 36 may be easily inserted in such a manner that the heating means frame 36 is guided in the direction, in which it needs to be inserted, by the protrusions and the heating means frame coupling recesses 37 when the heating means frame 36 is inserted into the heating means mounting hole 20 of the frame 2.

Furthermore, at least two hooks are formed on some surfaces of the heating means frame 36 and the heating means mounting hole 20, so that the heating means frame 36 is firmly fixed to the frame 2 by these hooks.

Meanwhile, at least one air circulation hole 26 is formed in a portion of the frame 2 adjacent to the heating means mounting hole 20 into which the heating means 3 is mounted, and is formed to pass through the frame 2 in the vertical direction, so that surrounding air is made to move through the air circulation hole 26.

The heating member 34 has an inverted U-shaped side section and has one or more ribs, connecting both sides, therein, and the heater member 32 is configured to be provided in a compressed state on the uppermost rib of the heating member 34.

Accordingly, the heater element 32 is spaced apart from the water stored in the water storage part 14, and the lower portion of the heating member 34 may be positioned to be immersed in the water stored in the water storage part 14.

The heating means 3 includes connection lines 33 that are connected to the heater member 32 and protrude from one side of the upper portion of the heating means frame 36. Accordingly, the heating means 3 may be electrically connected to the controller that performs operations according to a user's settings, and may be operated by receiving power and signals from the controller.

In addition, the heating means 3 may include a sealing member 35 that is provided on the uppermost rib of the heating member 34 in order to waterproof the heater member 32 provided in a compressed state provided on the uppermost rib of the heating member 34 to block each of both sides, as shown in FIGS. 4a and 4b. Accordingly, since the heater member 32 has a structure that can completely block multiple problems caused by water, durability can be improved.

The sealing member 35 is made of silicone. One of the sealing members 35 may have through holes through which the above-described connection lines 33 pass.

The heating member 34 is a member that generates water vapor by heating water.

The heating member 34 is made of a metal having high thermal conductivity. Preferably, the heating member 34 of the humidification apparatus 1 according to an embodiment of the present invention may be made of aluminum. The reason for this is that aluminum is light and strong, has desirable thermal conductivity, and is resistant against moisture. Accordingly, when the heater member 32 generates heat, the heating member 34 may rapidly heat water by dissipating the heat and, at the same time, the corrosion of the heating member 34 caused by water may be minimized.

The heating means 3 is fabricated by insert-injecting the heating member 34, having the heater member 32 therein in a compressed state, into the heating means frame 36.

This heating means frame 36 is made of a heat-resistant material that can withstand even when the temperature of the heating member 34 becomes high when the heater member 32 generates heat. The heating means frame 36 of the humidification apparatus 1 according to an embodiment of the present invention may be made of polycarbonate that can resist acid and heat desirably.

However, the present invention is not limited thereto. As long as another type of resin other than polycarbonate has high heat resistance to withstand the high-temperature heat of the heater member 32 and the heating member 34, the heating means frame 36 may be made of the resin.

Meanwhile, a coating layer (not shown) may be formed on both exposed outer surfaces of the lower portion of the heating member 34 made of aluminum. The coating layer is formed to protect the exposed outer surfaces of the heating member 34 from corrosion and to increase the heat dissipation efficiency of the heating member 34.

The coating layer of the humidification apparatus 1 according to an embodiment of the present invention is made of a heat-resistant Teflon coating material. The Teflon coating material is a material having advantages such as low friction, heat resistance, non-adhesiveness, and weather resistance. However, the present invention is not limited thereto. The coating layer prevents the exposed outer surfaces of the heating element 34 from being corroded, and it may be possible to apply other materials capable of increasing the heat dissipation efficiency of the heating member 34.

The Teflon coating material includes a fluoride component as the main component thereof. The fluoride component acts as a protective film, and prevents foreign substances, contaminants, and the like in water from adhering to the exposed outer surfaces of the heating member 34.

The coating layer is formed on the exposed outer surfaces of the heating member 34 by using a Teflon coating material, as described above, so that the corrosion of the heating member 34 made of aluminum may be further minimized. At the same time, the heat dissipation efficiency of the heating member 34 may also be improved because contaminants such as minerals and foreign substances in the water are not adhered.

The heating means 3 configured as described above is injected and manufactured in a single shape when it is manufactured. Accordingly, when the heating means 3 is replaced, there is no inconvenience of having to separate the heating means frame 36 constituting the outer shape of the heating means 3 and the heating member 34 having the heater member 32 therein in a compressed state. Furthermore, when maintenance is performed, the heating means frame 36 is separated from the frame 2, so that the repair and replacement of parts are easy.

The heating means 3 of the humidification apparatus 1 according to an embodiment of the present invention may include a safety cover 38 with at least one hole that exposes a portion while surrounding both outer surfaces of the lower portion of the exposed heating member 34. The safety cover 38 serves to protect an administrator during the maintenance of the humidification apparatus 1.

Next, the fan assembly 5 transfers or discharges water vapor, generated from the water heated by the heating means 3, to a space requiring humidification.

The fan assembly 5 includes a plurality of blades configured to rotate and generate wind, and a motor configured to rotate the blades.

Since this fan assembly 5 is one of general types of blowing fans, a detailed description thereof will be omitted.

The fan assembly 5 contains a number of parts, such as the motor configured to rotate the plurality of blades, therein. Furthermore, the fan assembly 5 is connected to the controller by a connection line (not shown), and thus receives power and signals and performs operations.

Accordingly, as the water vapor generated from the water heated by the heating means 3 rises upward in the apparatus, it is discharged to the humidification target space 12, which is a space requiring humidification, by the blowing operation of the fan assembly 5, and thus humidification is performed.

The fan assembly 5 is fixed and mounted in the fan mounting depression 22 of the frame 2, and is arranged as shown in FIG. 5 so that air can be blown into a space requiring humidification.

The fan assembly 5 is mounted in the fan mounting depression 22 as described above, so that it is not always exposed to the surface of water, with the result that it may be possible to prevent the corrosion of parts attributable to the evaporation of water.

In this case, as shown in FIG. 2, in the fan mounting depression 22, at least two protrusions configured to support the fan assembly 5 are formed to protrude upward by a predetermined length.

Furthermore, hooks configured to firmly fix the fan assembly 5 are formed on the side surfaces of the protrusions, so that the fan assembly 5 can be easily fixed to the fan mounting depression 22.

Meanwhile, an air inlet hole 24 configured to transfer air is formed through one side (refer to FIG. 2) of the fan mounting depression 22.

The air inlet hole 24 is a hole formed to allow air to easily flow into the fan assembly 5 by the blowing operation of the fan assembly 5.

The water vapor generated from the water heated by the heating means 3 rises. At this time, the air flows into the fan assembly 5 through the air inlet hole 24 and is transferred to a space requiring humidification by the blowing operation of the fan assembly 5.

A process in which the humidification apparatus 1 according to an embodiment of the present invention is contained in an apparatus and humidifies the inside of the apparatus will be described below with reference to FIGS. 5 and 6.

In order to help the understanding of a process in which the humidification apparatus 1 of the present invention performs operation and humidification, there will be described an example in which the humidification apparatus 1 is mounted in a humidification housing 10 having a rectangular parallelepiped shape as shown in the drawing.

The humidification housing 10 is formed in a rectangular parallelepiped shape as shown in FIGS. 5 and 6, and the inside of the humidification housing 10 includes the humidification target area 12 configured such that humidification is performed therein and the water storage part 14 configured such that water is to be stored therein.

In this case, the humidification target area 12 and the water storage part 14 are formed such that the spaces thereof are separated from each other by a partition plate 16.

In addition, an air transfer hole 17 that is formed such that the water vapor generated in the water storage part 14 can be transferred to the humidification target area 12 by the humidification apparatus 1 is formed through the right side of the upper end of the partition plate 16 (based on FIG. 5).

A process in which humidification is performed in the humidification housing 10 having the above-described shape will be described below.

First, the humidification apparatus 1 of the present invention is installed inside the water storage part 14 of the humidification housing 10.

In this case, the humidification apparatus 1 needs to be installed such that the lower part of the heating member 4 of the heating means 3 is immersed in the water stored in the water storage part 14, and the fan assembly 5 is preferably installed to face the air transfer hole 17 of the partition plate 16.

Next, a user introduces water into the water storage part 14 before operating the humidification apparatus 1.

In this case, it is preferable that the amount of water introduced is determined such that the exposed outer surfaces of the lower portion of the heating member 34 are sufficiently submerged in water.

In addition, the connection wires 33 connected to the heater member 32 of the heating means 3 of the humidification apparatus 1 is connected with the controller, and thus operation is in a standby state.

Next, a user sets a maximum temperature value required by the humidification target area 12 through the controller, and starts the operation of the humidification apparatus 1.

Accordingly, the heater member 32 of the heating means 3 of the humidification apparatus 1 generates heat.

The water stored in the water storage part 14 is heated by the heating member 34 to which heat is transferred due to the heat generated by the heater member 32, and thus the water is vaporized into water vapor.

As shown in FIG. 6, the vaporized water vapor rises and is transferred to the fan assembly 5 through the air inlet hole 24 of the frame 2.

In addition, the transferred air is introduced into the humidification target area 12 through the air transfer hole 17 of the partition plate 16 while being moved from a location behind the fan assembly 5 to a location in front of the fan assembly 5 by the blowing operation of the fan assembly 5.

Accordingly, the inside of the humidification target area 12 may be humidified.

In addition, the humidification apparatus 1 may include a temperature/humidity sensor 6 provided to be spaced apart from the fan assembly 5 toward the humidification target area 12, which is a space requiring humidification, and configured to detect temperature and humidity between the fan assembly 5 and the humidification target area 12 and to, if a set humidity is not reached even after a set temperature was reached and then a predetermined period has elapsed, send a signal indicating that there is no water in the water storage part 12.

For example, if the humidity value detected by the temperature and humidity sensor 6 does not reach the set humidity value even after the user reached the maximum temperature value required by the humidifier 12 through the controller and then a predetermined period has elapsed, it is determined that the amount of water stored in the water storage unit 14 is insufficient or there is no water.

The reason for this is that although the temperature and humidity values sensed by the temperature and humidity sensor 6 maintain the set temperature and humidity values when the heating member 34 is submerged in water, there is insufficient or no water in the water storage unit 14 when the humidity value detected by the temperature and humidity sensor 6 does not reach the set humidity value.

Accordingly, when the temperature and humidity values set by the temperature and humidity sensor 6 are not reached even after a predetermined period has elapsed, it is determined that there is insufficient or no water in the water storage part 14, and the controller provides notification that there is no water in the water storage part 14.

In this way, when it is known that there is insufficient or no water, a user may replenish the water storage part 14 with water, thereby allowing the humidification apparatus 1 to operate.

In addition, when a user wants to receive a lower level of humidification according to his or her preference, it may be possible to control the humidification to a relatively low level by lowering the set temperature and humidity values of the temperature and humidity sensor 6.

This is performed through the controller that allows a user to make control settings.

Accordingly, the controller provides notification that the water in the water storage unit 14 is insufficient, thereby guiding a user through the replenishment of water.

Humidification is performed using the humidification apparatus 1 according to the embodiment of the present invention, and thus a humidification operation required by a user may be performed. In particular, there is an advantage in that the durability and quality of the humidification apparatus 1 may be improved by the heating means 3 having a structure capable of overcoming multiple problems caused by water.

The humidification apparatus according to an embodiment of the present invention includes the heating means, including the heating member configured such that the lower portion thereof is immersed in the water stored in the water storage part and heats the water, and the heater member provided in a compressed state in the upper portion of the heating member to be spaced apart from water and configured to generate heat to be transferred to the heating member. Accordingly, multiple problems in the heating means caused by water may be overcome. As a result, the humidification apparatus capable of stably performing humidification in an apparatus may be provided.

In addition, the humidification apparatus according to an embodiment of the present invention includes the temperature and humidity sensor that detects the temperature and humidity between the fan assembly and the space requiring humidification and sends a signal to provide notification that there is no water in the water storage part. Accordingly, a user may easily become aware that there is no water in the water storage part of the humidification apparatus. As a result, the humidification apparatus capable of efficiently performing humidification in an apparatus may be provided.

Therefore, the humidification apparatus according to the present invention has the following advantages:

First, there are provided the heating means configured to heat water and the fan assembly configured to transfer water vapor, generated from the water heated by the heating means, to a space requiring humidification. Accordingly, the humidification apparatus having the above-described simple configuration is installed in an apparatus, and performs humidification.

Second, the heating means configured to heat water includes the heater member configured to generate heat and the heating member configured to receive heat from the heater member and heat water. The heating member is made of aluminum (Al). Accordingly, there is an advantage in that the heat is rapidly and easily radiated to the outside by the heating member made of aluminum when the heater member generates heat.

Third, there is a space in the lower part of the heating member configured to compress the heater member provided in the inside of the upper part thereof. The space and the outer periphery of the space are filled with the heating means frame, which is a filler made of a material having desirable heat resistance. Accordingly, there are advantages in that the heater member and the heating member may be protected from external impact and the high-temperature heat of the heater member and the heating member may strongly be withstood.

Fourth, the heating member made of aluminum is resistant against moisture, so that the corrosion caused by water may be minimized.

Fifth, the heating means is formed by integrating the heater member, the heating member configured to compress and fix the heater member, and the heating means frame mounted on the frame while enclosing them with one another. Accordingly, there is an advantage in that repair and replacement are easy in the event of the failure of parts.

Sixth, although the conventional humidification apparatus performs humidification in the state in which the fan assembly is always exposed above water, the fan assembly is vertically mounted in the fan mounting depression formed in the frame in the humidification apparatus according to the present invention. Accordingly, the fan assembly is not always exposed above water, so that there is an advantage in that the problems of the corrosion and failure of parts attributable to the evaporation of water are reduced.

Seventh, the humidification apparatus according to the present invention is fixed by inserting and hooking the heating means and the fan assembly to the plate-shaped frame. Accordingly, there is an advantage in that the maintenance and replacement of various parts may be easily performed and parts may be conveniently removed, separated, and cleaned even when the humidification apparatus is cleaned.

While the embodiments of the present invention have been described with reference to the accompanying drawings, it will be appreciated by those of ordinary skill in the art to which the present invention pertains that the present invention may be embodied in other specific forms without changing the technical spirit or essential features of the present invention. Therefore, it should be understood that the embodiments described above are illustrative but not restrictive in all respects.

What is claimed is:

1. A humidification apparatus comprising:
a frame installed inside a water storage part in which water is stored, and having a heating means mounting hole and fan mounting depression in which parts for providing moisture are mounted;
a heating means inserted into and mounted in the heating means mounting hole of the frame, and configured to heat the water stored in the water storage part; and
a fan assembly mounted vertically in the fan mounting depression of the frame, and configured to transfer or discharge water vapor, generated from the water heated by the heating means, to a space requiring humidification;
wherein the heating means includes:
a heating member configured such that a lower portion thereof is immersed in the water stored in the water storage part and heats the water;
a heater member provided in a compressed state in an upper portion of the heating member to be spaced apart from the water, and configured to generate heat to be transferred to the heating member; and
a heating means frame configured to cover a top of the heating member provided with the heater member, to expose both outer surfaces of a lower portion of the heating member, and to fill an inside of the heating member.

2. The humidification apparatus of claim 1, wherein:
the heating member has an inverted U-shaped side section, and also has at least one rib, connecting both sides thereof, therein; and
the heater member is provided in a compressed state on an uppermost rib of the heating member.

3. The humidification apparatus of claim 1, wherein the heater member is one of a positive temperature coefficient (PTC) heater, a resistance heater, and a ceramic heater.

4. The humidification apparatus of claim 1, wherein the heating means includes connecting lines that are connected to the heater member and protrude from one side of an upper portion of the heating means frame.

5. The humidification apparatus of claim 1, further comprising a temperature and humidity sensor that is provided to be spaced apart from the fan assembly to a space requiring humidification, detects a temperature and humidity between the fan assembly and the space requiring humidification, and sends a signal providing notification that there is no water in the water storage part when a set humidity is not reached even after a set temperature was reached and then a predetermined period has elapsed.
